(19) United States
(12) Patent Application Publication
(10) Pub. No.: US 2026/0304037 A1
(43) Pub. Date: Oct. 1, 2026

(54) SPEAKER PROTECTION TECHNIQUES

(71) Applicant: HARMAN BECKER AUTOMOTIVE SYSTEMS, INC, Novi, MI (US)

(72) Inventor: James McCallister PORTER, Highland Park, MI (US)

(21) Appl. No.: 19/094,524

(22) Filed: Mar. 28, 2025

(51) Int. Cl. H04R 3/00; H04R 5/02; H04S 3/00

(52) U.S. Cl. CPC H04R 3/007; H04R 5/02; H04S 3/008; H04S 2400/01; H04S 2400/13

(57) ABSTRACT

In various embodiments, a computer-implemented method comprises receiving a multi-channel input signal corresponding to an audio source and determining that a first input signal for a first channel from the multi-channel input signal exceeds an input level threshold. The computer implemented method further comprises determining a first amount of time that the first channel exceeds the input level threshold, computing a first release time for a first gain limiter associated with the first channel based on the first amount of time and an analysis of a plurality of channels from the multi-channel input signal, generating a first output signal for the first channel based on the first gain limiter and the first input signal, and causing playback of the first output signal by a first speaker.

### BACKGROUND

### Field of the Various Embodiments

The present disclosure relates to the field of audio processing, and more particularly to speaker protection techniques.

### Description of the Related Arts

Modern vehicles or theater environments include audio systems that receive audio inputs from various sources. An audio source is processed by an audio system and one or more output signals are generated. The output signals are provided to one or more speakers for playback in a listening environment. Speaker protection techniques are often utilized by the audio system to limit the risk of damage to the loudspeakers in the system by ensuring that voltage levels are at or below a threshold. Conventional speaker protection techniques involve a gain limiter that limits or eliminates signal gain for an output signal if the signal level is above a threshold level. Gain limiters are often configured with an attack time and a release time. The attack time specifies how quickly gain limiting is activated when a given input signal exceeds a threshold. The release time specifies how gradually gain limiting is deactivated after gain limiting is initially activated.

One drawback of conventional speaker protection techniques that utilize gain limiting is the impact that gain limiting can have on playback by the loudspeakers in the audio system. Prior art techniques often utilize a gain limiter that is configured with a fixed release time. Depending upon the source signal, the fixed release time can cause pumping or distortion effects, which also impacts the quality of the listening experience for the user. For example, if a source signal exceeds a threshold level repetitively but for short periods of time, the gain limiter configured with a fixed release time that is too long can cause pumping effects because the system is activating gain limiting for the portion of the signal that exceeds the threshold and gradually deactivating gain limiting, which causes gain limiting to be active even when the source signal does not exceed the threshold. Similarly, the gain limiter configured with a fixed release time that is too short can cause distortion effects because the system is very quickly activating and deactivating gain limiting. Additionally, when the fixed release time operates on separate channels, an unnatural sound output by the system can occur when some channels are being gain limited while others are not. This mis-match in gain limiting can create distortions and a poor listening experience.

Therefore, there is a need for improved speaker protection techniques that improve the listening experience by minimizing distortion and pumping effects while preserving as much of the natural sound quality of the audio system as possible.

### SUMMARY

In various embodiments, a computer-implemented method comprises receiving a multi-channel input signal corresponding to an audio source, determining that a first input signal for a first channel from the multi-channel input signal exceeds an input level threshold, determining a first amount of time that the first channel exceeds the input level threshold, computing a first release time for a first gain limiter associated with the first channel based on an analysis of the plurality of channels from the multi-channel input signal, generating a first output signal for the first channel based on the first gain limiter and the first input signal channel, and causing playback of the first output signal by a first speaker.

Further embodiments provide, among other things, one or more non-transitory computer-readable media and systems configured to implement the method set forth above.

At least one technical advantage of the disclosed approach relative to the prior art is that, with the disclosed techniques, speaker protection is achieved while minimizing distortion and pumping effects caused by gain reduction of the output signal that is provided to respective channels in the audio system. By dynamically adjusting gain reduction based upon an analysis of an input signal on a channel-by-channel basis, examples of the disclosure provide speaker protection that is tailored to the properties of the input signal. Dynamic gain reduction can be implemented with a faster release time after a transient signal that exceeds a signal level threshold and a longer release time after a sustained input signal above the signal level threshold. Additionally, the effort to tune and integrate a head unit or sound processor into an audio system is reduced because a tuning engineer need not select a release time associated with a given listening environment. Finally, another technical advantage of the disclosed techniques is improving the listening experience of users by reducing the distortion caused by gain limiting mismatch across different channels in an audio system. These technical advantages provide one or more technological improvements over prior art approaches.

### BRIEF DESCRIPTION OF THE DRAWINGS

In order to more clearly illustrate the technical solutions of the embodiments of the present disclosure, the accompanying drawings to be used in the description of the embodiments will be briefly introduced below, and it will be obvious that the accompanying drawings in the following description are only some of the embodiments of the present disclosure, and that for those of ordinary skill in the art, other accompanying drawings can be obtained based on the se drawings without making creative labor. The following accompanying drawings are not intentionally drawn in equal proportions to the actual dimensions.

FIG. 1 illustrates a schematic diagram of an audio system according to various embodiments;

FIG. 2A, illustrates an example input signal for a channel from a multi-channel input signal 114 according to various embodiments;

FIG. 2B illustrates how the speaker protection application utilizes one or more gain limiters to reduce or limit damage to speakers;

FIG. 2C illustrates an example of a release time utilized by a gain limiter associated with an output channel of the speaker protection application;

FIG. 3 shows an example scenario illustrating how speaker protection application analyzes a multi-channel input signal to generate output signals that are transmitted to speakers in an audio system according to various embodiments; and

FIG. 4 is a flow diagram of method steps for performing gain limiting, according to various embodiments.

### DETAILED DESCRIPTION

In the following description, numerous specific details are set forth to provide a more thorough understanding of various embodiments. However, it will be apparent to those skilled in the art that the inventive concepts may be practiced without some or all of these specific details.

### Audio System

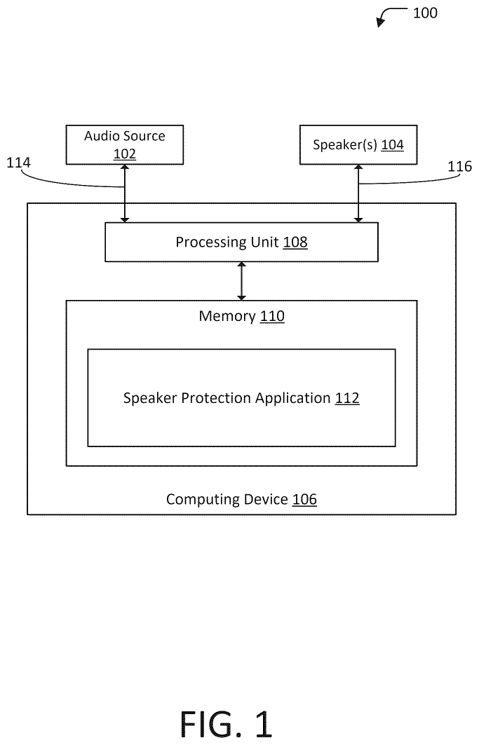

FIG. 1 is a schematic diagram illustrating an audio system 100 according to various embodiments. As shown, the audio system 100 includes, without limitation, one or more audio sources 102, one or more speakers 104, and a computing device 106. The computing device 106 includes, without limitation, a processing unit 108 and memory 110. The memory 110 stores, without limitation, a speaker protection application 112. The computing device 106 receives a multi-channel input signal 114 from the one or more audio sources 102 and generates output signals 116 that are transmitted to the computing device 106 according to various embodiments.

Computing device 106 is an audio processing device, such as a vehicle audio system, a home theater system, sound system, and/or similar system/device. In some embodiments, computing device 106 is included in one or more devices, such as consumer products (e.g., portable speakers, gaming consoles, entertainment systems, etc.), vehicles (e.g., the head unit of a car, truck, van, bus, train, airplane, or other vehicle), smart home devices (e.g., smart lighting systems, security systems, digital assistants, etc.), communications systems (e.g., conference call systems, video conferencing systems, speaker amplification systems, etc.), mobile devices (e.g., smart phones, tablets, etc.), computers, and so forth. In some embodiments, computing device 106 is located in various acoustic environments including, without limitation, vehicles, indoor environments (e.g., living room, conference room, conference hall, home office, etc.), and/or outdoor environments, (e.g., patio, rooftop, garden, etc.). Computing device 106 is configured to receive audio content from the one or more audio sources 102 and output the audio content in order to generate sound and/or quiet zones in a listening environment.

The one or more audio sources 102 can include any technically feasible device or component capable of providing audio signals to computing device 106. For example, each of the one or more audio sources 102 can be an on-board media player, a streaming service accessed via a network connection, a media stream (e.g., from a cellular or smart telephone), or a storage device containing stored music, movie soundtracks, spoken word content, and/or other audio files. Each of the one or more audio sources 102 can adapt or switch content based on user preferences or selections, sensor input, system configurations, and/or the like. In one example, the one or more audio sources 102 provides a multi-channel input signal the computing device 106. The computing device 106 generates a corresponding output signal for each speaker in the audio system 100 based on the multi-channel input signal.

The one or more speakers 104 convert an output signal into audible sound that is played back within an environment, such as a vehicle cabin. The output signal is generated by computing device 106 and transmitted to one or more speakers 104 for playback. The one or more speakers 104 can be grouped into various categories. For example, speakers 104 can be grouped according to frequency response, a location within the environment, a channel category associated with a multi-channel signal, or a spatial grouping in the case of a spatial audio encoded input signal. For example, frequency response groupings can include low frequency, middle frequency, and high frequency groupings. As another example, speakers 104 can be grouped by speaker type, such as tweeter, mid-woofer, subwoofer. Location groupings can include where in the listening environment, such as in a vehicle cabin, a grouping of speakers 104 are located. For example, certain speakers 104 can be positioned in the front seating area of the vehicle, the rear seating area of the vehicle, in the vehicle headrests, in vehicle pillars, the dash, within seats, or other locations within a vehicle environment. Speakers 104 can also be grouped according to a channel or channel category of a multi-channel audio system to which a speaker 104 is assigned. For example, certain implementations of an audio system 100 include one or more center channel speaker, one or more left channel speakers, one or more right channel speakers, one or more left rear channel speakers, one or more right rear channel speakers, one or more overhead presence speakers, upwardly directed speakers, and so on. Channel categories of speakers can include the left and right channel speakers in a common category, the rear speakers in a common category, or the presence speakers in a common category. Spatial groupings of speakers 104 can specify the location of speakers 104 in a listening environment so that an audio object created using a spatial audio encoding format can be mapped to one or more of the speakers 104.

Each of the one or more speakers 104 can be any technically feasible type of speaker. Each of the speakers 104 can be damaged if the voltage level of an output signal provided to a respective speaker 104 exceeds a damage threshold. Different speakers, depending on the manufacturer, frequency response, location within a vehicle, channel type, or other classification, can have different damage thresholds. In multi-channel environments in which there are potentially many different discrete output signals being generated, the voltage levels of the output signals can vary.

Processing unit 108 controls the overall operation of computing device 106. Processing unit 108 is configured to read and write data from memory 110. Processing unit 108 can include any suitable hardware processor or combination of hardware processors, including one or more central processing units (CPUs), graphics processing units (GPUs), digital signal processors (DSPs), field-programmable gate arrays (FPGAs), or application-specific integrated circuits (ASICs), and/or any other type of processing unit, or a combination of processing units, such as a CPU configured to operate in conjunction with a GPU. In general, processing unit 108 can be any technically feasible hardware unit capable of processing data, executing instructions, and/or performing signal processing tasks, such as the signal processing task of multi-channel input signal 114.

Memory 110 can include a random-access memory (RAM) module, a flash memory unit, or any other type of memory unit or combination thereof. The processing unit 108 is configured to read data from and write data to memory 110. In various embodiments, memory 110 includes non-volatile memory, such as optical drives, magnetic drives, flash drives, or other storage. In some embodiments, separate data stores, such as an external data stores (not shown) included in a network (“cloud storage”) can supplement the memory 110. The speaker protection application 112 within memory 110 can be executed by the processing unit 108 to implement the overall functionality of the computing device 106 and, thus, to coordinate the operation of the audio system 100 as a whole.

The speaker protection application 112 performs speaker protection techniques by processing a multi-channel input signal from an audio source 102 and generating respective output signals for the one or more speakers 104 that limit the signal gain to prevent or limit the risk of damage to the speakers 104. An audio source 102 provides a multi-channel input signal 114 to the computing device 106. Speaker protection application 112 processes the multi-channel input signal 114 to generate output signals 116 for the various speakers 104 in the audio system 100. The output signals 116 generated by the speaker protection application 112 are transmitted to the speakers 104, causing the speakers 104 to generate sound within the listening environment.

Speaker protection application 112 utilizes various techniques to perform speaker protection according to embodiments of the disclosure. In one example, speaker protection application 112 utilizes one or more gain limiters that limit the signal gain applied to output signals 116 that are generated for each of the respective speakers 104. A gain limiter limits the gain applied to an output signal 116 to a maximum voltage if the input signal associated with a particular channel of the multi-channel input signal 114 exceeds an input signal level threshold. In other words, the gain limiter limits the voltage of the output signal 116 if a corresponding input signal would otherwise cause the output signal 116 to exceed an output signal level threshold that could cause damage to one or more speakers 104. A gain limiter is characterized by an attack time, which specifies how quickly the gain limiter activates. A gain limiter is also characterized by a release time, which specifies how gradually the gain limiter deactivates gain limiting of an output signal 116 after the input signal is below the input signal level threshold.

When an input signal for a channel exceeds an input signal level threshold, speaker protection application 112 computes a release time utilized for a gain limiter that is specific to a particular channel of the output signals 116 based on an analysis of a channel of the input signal. Because the multi-channel input signal 114 includes multiple channels, speaker protection application 112 analyzes the multi-channel input signal 114 to determine which of the channels has a corresponding input signal that exceeds an input signal threshold. If a channel from the multi-channel input signal 114 exceeds the input signal threshold, the speaker protection application 112 activates a gain limiter corresponding to the channel. The gain limiter limits signal gain for the output signal generated for the channel to an output signal threshold. Speaker protection application 112 calculates a release time utilized by the gain limiter for a particular speaker 104 based on the input signal that exceeds the threshold.

In one example, speaker protection application 112 calculates a release time only for a single channel so that only one speaker 104 out of multiple speakers 104 in the audio system 100 will be gain limited. The release time for the gain limiter associated with the speaker 104 for that input signal is based on the amount of time that the input signal level exceeds the input level threshold. In one implementation, the release time is proportional to the amount of time that the input signal level exceeds the input signal level threshold. Accordingly, in the event of a transient signal that exceeds the input signal level threshold, the release time computed by speaker protection application 112 is also relatively transient. In one implementation, a minimum release time for transient occurrences can be utilized to reduce distortion or pumping. In the event of an input signal that exceeds that input level threshold for a sustained period of time, the release time computed by speaker protection application 112 can also be sustained. Therefore, in one implementation, the release time computed for a gain limiter for a given speaker 104 is proportional to the amount of time the input signal exceeds the input signal level threshold.

Speaker protection application 112 assesses each channel of multi-channel input signal 114 in parallel. Accordingly, multiple channels corresponding to different speakers 104 in the audio system 100 might exceed a respective input level threshold for different periods of time. Accordingly, in one scenario, speaker protection application 112 calculates individualized release times for the gain limiters corresponding to the different speakers 104. In one implementation, an average between the release times can be utilized for the gain limiters of the speakers 104 corresponding to channels exceeding an input signal level threshold. In another example, a maximum, or the longest, of the computed release times can be utilized for the gain limiters corresponding to the speakers 104. In another example, the release time of one channel could be decreased to mask the pumping effect of another channel. In other implementations, any triangular co-norm function can be used to compute a common release time based on each of the individual release times.

Speaker protection application 112 utilizes a global release time for gain limiters corresponding to speakers 104 in the audio system regardless of whether the input signal for a particular channel exceeds the input signal level threshold. For example, based on one or more channels having an input signal exceeding an input signal level threshold, speaker protection application 112 calculates a global release that is applied to a remainder of gain limiters for speakers 104 that is proportional to the individualized release time computed for those channels exceeding the threshold. For example, the speaker protection application 112 computes a global release time based on a mathematical relationship with the individualized release time that is computed for one or more channels exceeding the threshold. The global release time can be the average of the individualized release time or calculated based on a proportion relative to the individualized release time. In some embodiments, a global release time is utilized to reduce distortion that would be caused by gain limiting mismatch across different channels in the audio system 100.

In another embodiment, speaker protection application 112 calculates sub-global release times based on a categorization of one or more speakers 104. For example, speaker protection application 112 utilizes a common release time for speakers 104 in the same location group, spatial group, frequency response group, or channel group. In other words, all of the speakers 104 located in the front seating area can be associated with a common release time, while all speakers 104 located in a rear seating area can be associated with a different release time. Speaker protection application 112 can utilize a common release time for symmetrical pairings or groupings of speakers 104. In other words, the gain limiters for the left front and right front speakers are configured with a common release time if either channel corresponding to either speaker 104 exceeds the input signal level threshold.

### Gain Limiter Release Time

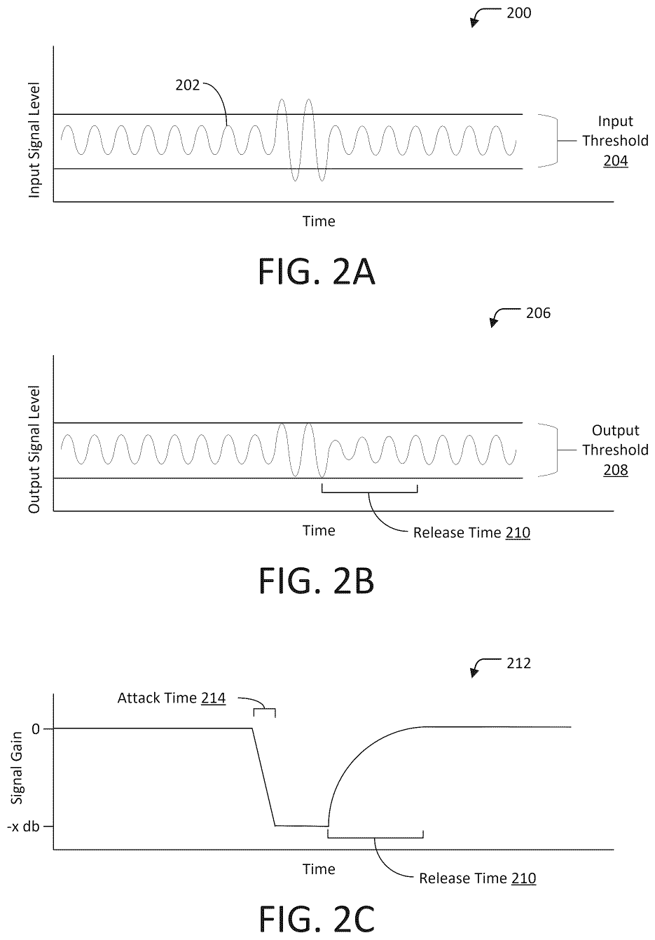

Referring next to FIG. 2A, diagram 200 illustrates an example input signal 202 for a channel from a multi-channel input signal 114 according to various embodiments. The example input signal 202 represents a single channel of a multi-channel input signal 114 associated with an audio source 102. The input signal level threshold 204 represents an input signal voltage level that would result in an output signal that exceeds a voltage threshold for a speaker 104 or set of speakers 104 corresponding to the channel. As shown in diagram 200, the input signal 202 corresponding to the channel exceeds an input signal level threshold 204. Without any speaker protection techniques, a corresponding output signal that is generated based on the input signal level threshold 204 would result in output signal voltage levels that exceed an output signal level threshold 208. Exceeding the output signal level threshold 208 could result in damage to a speaker 104 to which a corresponding output signal is transmitted.

Referring next to FIG. 2B, diagram 206 illustrates how the speaker protection application 112 utilizes one or more gain limiters to reduce or limit damage to speakers 104. As illustrated in diagram 206, speaker protection application 112 limits the output voltage for an output signal generated based on the input signal shown in diagram 200. When the input signal experiences an excursion that exceeds input signal level threshold 204, speaker protection application 112 limits the corresponding output signal to an output signal level threshold 208, which represents a maximum output voltage. The output signal level threshold 208 can be specified as the maximum voltage that a speaker 104 can accept without experiencing damage. In some embodiments, output signal level threshold 208 is specified by a tuning engineer that tunes and integrates the audio system 100 in a vehicle. In other embodiments, output signal level threshold 208 is specified according to the specification of a speaker 104 that is utilized for a particular channel of audio system 100.

Accordingly, speaker protection application 112 utilizes gain limiters for each speaker 104 coupled to computing device 106 to limit the output signal voltage at or beneath output signal level threshold 208. A gain limiter limits the output signal voltage for an output signal that is transmitted to a respective speaker 104. Speaker protection application 112 limits the output signal voltage of the output signal corresponding to the input signal for the excursion exceeding the input signal level threshold 204. Speaker protection application 112 limits the output signal voltage to output signal level threshold 208. Additionally, as described above, speaker protection application 112 computes a release time 210 for the gain limiter corresponding to the channel based on the length of the excursion above input signal level threshold 204. As shown in diagram 206, during the release time 210 utilized by speaker protection application 112, the output signal gradually returns to a level corresponding to the input signal 202 because gain reduction is gradually deactivated during a release time phase utilized by the gain limiter corresponding to the channel.

Referring next to FIG. 2C, diagram 212 illustrates an example of a release time 210 utilized by a gain limiter associated with an output channel of the speaker protection application 112. Diagram 212 plots gain reduction that characterizes when gain reduction is applied and when gain reduction is released by a gain limiter associated with the output channel. In various embodiments, speaker protection application 112 activates gain reduction in advance of input signal 202 exceeding input signal level threshold 204. Speaker protection application 112 can buffer input signal 202 and identify when input signal 202 exceeds input signal level threshold 204. Speaker protection application 112 can then ramp up gain reduction during an attack time 214. Attack time 214 represents how much time is required for gain reduction to be activated within a gain limiter. Accordingly, speaker protection application 112 activates gain reduction beginning at time corresponding to an attack time 214 prior to the input signal 202 exceeding input signal level threshold 204 so that when the input signal 202 does exceed input signal level threshold 204, signal gain has been reduced to or below output signal level threshold 208. As shown in FIG. 2C, gain reduction is activated before the input signal of input signal 202 exceeds input signal level threshold 204. Prior to input signal 202 exceeding input signal level threshold 204, speaker protection application 112 activates gain reduction in a gain limiter corresponding to a channel associated with a speaker 104. Accordingly, gain reduction signal shown in diagram 212 ramps upward to limit the gain of a corresponding output signal to output signal level threshold 208. The duration of the period during which gain reduction is activated is referred to as the attack time and is also configurable within speaker protection application 112.

As shown in diagram 212, gain reduction is gradually deactivated once the input signal 202 no longer exceeds input signal level threshold 204. The amount of time by which gain reduction is deactivated is referred to as release time 210. The release time 210 for a given excursion of input signal 202 above input signal level threshold 204 is computed by speaker protection application 112 based upon an analysis of the length of the excursion as well as the input signal corresponding to the other channels of the audio system 100.

### Processing a Multi-Channel Input Signal

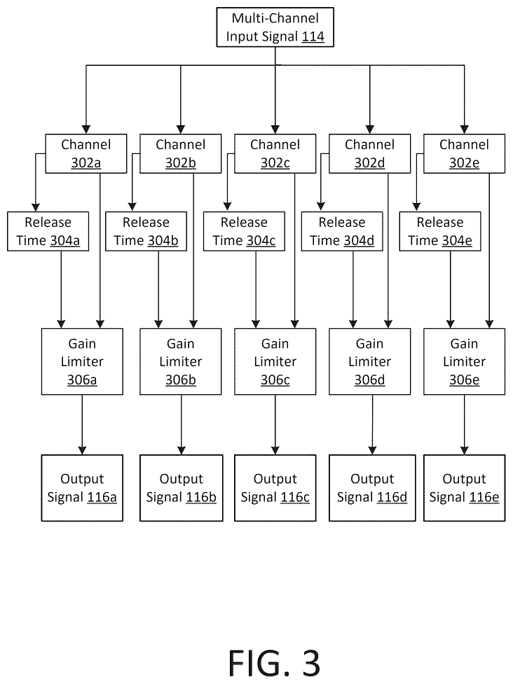

Referring next to FIG. 3, shown is an example scenario illustrating how speaker protection application 112 analyzes a multi-channel input signal 114 to generate output signals 116 that are transmitted to speakers 104 in an audio system 100 according to various embodiments. An audio source 102 provides a multi-channel input signal 114 to the computing device 106. Speaker protection application 112 separates the multi-channel input signal 114 into multiple channels 302, where each channel 302 can correspond to a speaker 104 in the audio system 100. Although a certain quantity of channels 302 is depicted in FIG. 3, it should be appreciated that the multi-channel input signal 114 can have more channels or fewer channels depending upon the quantity of speakers 104 in the audio system 100. Speaker protection application 112 separates the multi-channel input signal 114 into multiple channels 302 based on the location of a respective speaker 104 in the vehicle, a frequency response of the speaker 104, a spatial grouping of the speaker 104, a channel category, or another categorization of the speaker 104. Speaker protection application 112 identifies the channels 302 based on what portion of the multi-channel input signal 114 should be played back on a particular speaker 104 based upon the categorization of the speaker 104. For example, speaker protection application 112 separates channel 302a from multi-channel input signal 114 by identifying a portion of the multi-channel input signal 114 that should be played back on a respective speaker 104 in the audio system 100.

Speaker protection application 112 determines whether the input signal associated with the various channels 302 exceeds a respective input signal level threshold 204 for the channels 302. Upon determining whether one or more of the respective input signals corresponding to the channels 302 exceeds the input signal level threshold 204, speaker protection application 112 computes a release time 304 for each respective channel 302. Upon computing a release time 304 for each channel, the release time 304 is provided a respective gain limiter 306 for the channel 302. A respective output signal 116 for each channel 302 is generated based upon the release time 304 utilized for the gain limiter 306 for the channel. In some implementations, speaker protection application 112 determines that no gain limiting should be utilized for a respective channel 302, in which case an output signal 116 is generated for the channel 302 without any gain limiting.

In one scenario, speaker protection application 112 calculates a release time only for the channels 302 whose input signals exceed input signal level threshold 204 so that the speakers 104 assigned to the respective channels 302 receive a gain limited output signals 116. The release time for the gain limiter 306 associated with the speaker 104 is based on the amount of time that the input signal level exceeds the input signal level threshold 204. In one implementation, the release time 304 is proportional to the amount of time that the input signal level exceeds the input signal level threshold 204.

Speaker protection application 112 calculates individualized release times for the gain limiters corresponding to the different speakers 104. In one implementation, an average between the release times can be utilized for the gain limiters of the speakers 104 corresponding to channels 302 exceeding input signal level threshold 204. In another example, a maximum, or the longest, of the computed release time can be utilized for the respective gain limiter 306 corresponding to the speakers 104. In another example, the release time of one channel could be decreased to mask the pumping effect of another channel.

Speaker protection application 112 can also compute a global release time 304 that is utilized for all gain limiters 306 for speakers 104 in the audio system regardless of whether the input signal for a particular channel exceeds the input signal level threshold 204. In another embodiment, speaker protection application 112 calculates sub-global release times based on a categorization of one or more speakers 104. For example, speaker protection application 112 utilizes a common release time for speakers 104, in the same location, spatial group, frequency response group, or channel group. Speaker protection application 112 can utilize a common release time for symmetrical pairings of speakers 104. In other words, the gain limiters for the left front and right front speakers are configured with a common release time if either channel 302 corresponding to either speaker 104 exceeds the input signal level threshold 204. The common release time can be computed by calculating a release time for one or both of the channels 302 associated with an input signal 202 that exceeds the input signal level threshold 204. Speaker protection application 112 calculates the release time 210 for a channel in a symmetrical pair and utilizes the same release time 210 for the other speaker 104 in the symmetrical pair.

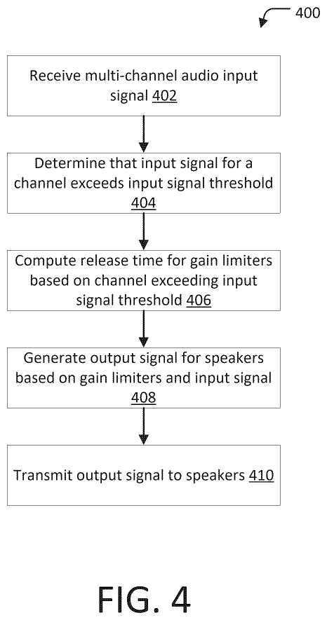

FIG. 4 is a flow diagram of method steps for processing a multi-channel input signal 114, utilizing speaker protection techniques, and generating corresponding output signals 116, according to various embodiments. Although the method steps are described with reference to the embodiments of FIGS. 1-3, persons skilled in the art will understand that any system configured to implement the method steps, in any order, falls within the scope of the present disclosure.

As shown, the method 400 begins at step 402, where speaker protection application 112 receives a multi-channel input signal 114. The multi-channel input signal 114 corresponds to an audio source 102 being played back by audio system 100. Speaker protection application 112 separates the multi-channel input signal 114 into multiple channels 302, where each channel 302 corresponds to a speaker 104 in the audio system 100. The multi-channel input signal 114 is separated into multiple channels 302 so that speaker protection application 112 can determine whether the input signal corresponding to a particular channel 302 exceeds a input signal level threshold 204.

At step 404, speaker protection application 112 determines that one or more input channels corresponding to a channel 302 exceeds an input signal level threshold 204 for the channel 302. The input signal level threshold 204 corresponds to an input signal that would cause the output signal 116 for the channel 302 to exceed an output signal level threshold 208 that could cause damage to the speaker 104 associated with the channel 302. As noted above, each speaker 104 can be associated with a different input signal level threshold 204 and output signal level threshold 208 depending upon the specific properties of a speaker 104.

At step 406, speaker protection application 112 computes a release time 304 for each gain limiter 306 corresponding to speakers 104 in the audio system 100. Speaker protection application 112 computes a release time 304 for each channel 302. Additionally, multiple channels corresponding to speakers 104 might exceed the input level threshold for different periods of time. In one implementation, an average between the release times can be utilized for the gain limiters of the speakers 104 corresponding to channels exceeding the input signal level threshold. In another example, a maximum, or the longest, of the computed release time can be utilized for the gain limiters corresponding to the speakers 104. In another example, the release time of one channel could be decreased to mask the pumping effect of another channel.

Speaker protection application 112 can also compute a global release time that is utilized for all gain limiters 306 for speakers 104 in the audio system 100 regardless of whether the input signal for a particular channel exceeds the input signal level threshold 204. In another embodiment, speaker protection application 112 calculates sub-global release times based on a categorization of one or more speakers 104. For example, speaker protection application 112 utilizes a common release time 304 for speakers 104, in the same location, spatial group, frequency response group, or channel group. Speaker protection application 112 can utilize a common release time 304 for symmetrical pairings of speakers 104. In other words, the gain limiters for the left front and right front speakers are configured with a common release time 304 if either channel corresponding to either speaker 104 exceeds the input signal level threshold 204. The common release time can be computed by calculating a release time for one or both of the channels 302 associated with an input signal 202 that exceeds the input signal level threshold 204. Speaker protection application 112 calculates the release time 210 for a channel in a symmetrical pair and utilizes the same release time 210 for the other speaker 104 in the symmetrical pair.

In sum, a speaker protection application performs speaker protection techniques in a multi-channel environment. The speaker protection application receives a multi-channel input signal corresponding to an audio source and determines that a first input signal for a first channel from the multi-channel input signal exceeds an input level threshold. The speaker protection application then determines a first amount of time that the first channel exceeds the input level threshold and computes a first release time for a first gain limiter associated with the first channel based on an analysis of the first amount of time and the plurality of channels from the multi-channel input signal. The speaker protection application then generates an output signal for the first channel based on the first gain limiter and the first input signal channel. The output signal is transmitted to a speaker, which emits sound corresponding to the output signal.

In some embodiments, the speaker protection application calculates a global release time for one or more channels with an input signal that may or may not exceed the input level threshold based on the first release time. The global release time can be proportional to or related to the first release time. The speaker protection application determines that a second input signal for a second channel from the multi-channel input signal exceeds the input level threshold. The speaker protection application then determines a second amount of time that the second channel exceeds the input level threshold and computes a second release time for a second gain limiter associated with the second channel based on the first release time, the second amount of time and the analysis of the plurality of channels from the multi-channel input signal. The calculation of the first release time is further based on the second release time. The speaker protection application then generates a second output signal for the second channel based on the second gain limiter and the second input signal, which is transmitted to a second speaker.

At least one technical advantage of the disclosed approach relative to the prior art is that, with the disclosed techniques, speaker protection is achieved while minimizing distortion and pumping effects caused by gain reduction of the output signal that is provided to respective channels in the audio system. By dynamically adjusting gain reduction based upon an analysis of an input signal on a channel-by-channel basis, examples of the disclosure provide speaker protection that is tailored to the properties of the input signal. Dynamic gain reduction can be implemented with a faster release time after a transient signal that exceeds a signal level threshold and a longer release time after a sustained input signal above the signal level threshold. Additionally, the effort to tune and integrate a head unit or sound processor into an audio system is reduced because a tuning engineer need not select a release time associated with a given listening environment. Finally, another technical advantage of the disclosed techniques is improving the listening experience of users by reducing the distortion caused by gain limiting mismatch across different channels in an audio system. These technical advantages provide one or more technological improvements over prior art approaches.

1. In some embodiments, a computer-implemented method comprises receiving a multi-channel input signal corresponding to an audio source, determining that a first input signal for a first channel from the multi-channel input signal exceeds an input level threshold, determining a first amount of time that the first channel exceeds the input level threshold, computing a first release time for a first gain limiter associated with the first channel based on the first amount of time and an analysis of a plurality of channels from the multi-channel input signal, generating a first output signal for the first channel based on the first gain limiter and the first input signal, and causing playback of the first output signal by a first speaker.

2. The computer-implemented method of clause 1, further comprising computing a global release time for a remainder of other channels of the multi-channel input signal based on the first release time, generating a respective output signal for each channel of the multi-channel input signal based on the global release time, and causing playback of the respective output signal by at least one speaker.

3. The computer-implemented method of clauses 1 or 2, wherein the global release time is based on a plurality of respective release times computed for each channel of the multi-channel input signal.

4. The computer-implemented method of any of clauses 1-3, wherein the global release time comprises a longest release time from the plurality of respective release times.

5. The computer-implemented method of any of clauses 1-4, further comprising identifying a second channel in a same frequency response group as the first channel, applying the first release time to a second gain limiter associated with the second channel, generating a second output signal for the second channel based on the second gain limiter and a second input signal corresponding to the second channel, and causing playback of the second output signal by a second speaker.

6. The computer-implemented method of any of clauses 1-5, further comprising identifying a second channel in a same location category as the first channel, applying the first release time to a second gain limiter associated with the second channel, generating a second output signal for the second channel based on the second gain limiter and a second input signal corresponding to the second channel, and causing playback of the second output signal by a second speaker.

7. The computer-implemented method of any of clauses 1-6, further comprising identifying a second channel in a same spatial group as the first channel, applying the first release time to a second gain limiter associated with the second channel, generating a second output signal for the second channel based on the second gain limiter and a second input signal corresponding to the second channel, and causing playback of the second output signal by a second speaker.

8. The computer-implemented method of any of clauses 1-7, wherein the first release time is based on a length of time that the first input signal exceeds the input level threshold.

9. The computer-implemented method of any of clauses 1-8, wherein the first release time is proportional to a length of time that the first input signal exceeds the input level threshold.

10. The computer-implemented method of any of clauses 1-9, further comprising determining that a second input signal for a second channel from the multi-channel input signal exceeds a second input level threshold, determining a second amount of time that the second channel exceeds the second input level threshold, computing a second release time for a second gain limiter associated with the second channel based on the first release time, the second amount of time and the analysis of the plurality of channels from the multi-channel input signal, wherein the first release time is further based on the second release time, generating a second output signal for the second channel based on the second gain limiter and the second input signal, and causing playback of the first output signal by the first speaker.

11. In some embodiments, one or more non-transitory computer-readable media store instructions that, that, when executed by one or more processors, cause the one or more processors to perform the steps of receiving a multi-channel input signal corresponding to an audio source, determining that a first input signal for a first channel from the multi-channel input signal exceeds an input level threshold, determining a first amount of time that the first channel exceeds the input level threshold, computing a first release time for a first gain limiter associated with the first channel based on the first amount of time and an analysis of a plurality of channels from the multi-channel input signal, generating a first output signal for the first channel based on the first gain limiter and the first input signal, and causing playback of the first output signal by a first speaker.

12. The one or more non-transitory computer-readable media of clause 11, the steps further comprising computing a global release time for a remainder of other channels of the multi-channel input signal based on the first release time, generating a respective output signal for each channel of the multi-channel input signal based on the global release time, and causing playback of the respective output signal by at least one speaker.

13. The one or more non-transitory computer-readable media of clauses 11 or 12, wherein the global release time is based on a plurality of respective release times computed for each channel of the multi-channel input signal.

14. The one or more non-transitory computer-readable media of any of clauses 11-13, wherein the global release time comprises a longest release time from the plurality of respective release times.

15. The one or more non-transitory computer-readable media of any of clauses 11-14, the steps further comprising identifying a second channel in a same frequency response group as the first channel, applying the first release time to a second gain limiter associated with the second channel, generating a second output signal for the second channel based on the second gain limiter and a second input signal corresponding to the second channel, and causing playback of the second output signal by a second speaker.

16. The one or more non-transitory computer-readable media of any of clauses 11-15, the steps further comprising identifying a second channel in a same location category as the first channel, applying the first release time to a second gain limiter associated with the second channel, generating a second output signal for the second channel based on the second gain limiter and a second input signal corresponding to the second channel, and causing playback of the second output signal by a second speaker.

17. The one or more non-transitory computer-readable media of any of clauses 11-16, the steps further comprising identifying a second channel in a same spatial group as the first channel, applying the first release time to a second gain limiter associated with the second channel, generating a second output signal for the second channel based on the second gain limiter and a second input signal corresponding to the second channel, and causing playback of the second output signal by a second speaker.

18. The one or more non-transitory computer-readable media of any of clauses 11-17, wherein the first release time is based on a length of time that the first input signal exceeds the input level threshold.

19. The one or more non-transitory computer-readable media of any of clauses 11-18, wherein the first release time is proportional to a length of time that the first input signal exceeds the input level threshold.

20. In some embodiments, a system comprises a memory storing instructions for a speaker protection application, and a processor coupled to the memory that implements the speaker protection application by performing the steps of receiving a multi-channel input signal corresponding to an audio source, determining that a first input signal for a first channel from the multi-channel input signal exceeds an input level threshold, determining a first amount of time that the first channel exceeds the input level threshold, computing a first release time for a first gain limiter associated with the first channel based on the first amount of time and an analysis of a plurality of channels from the multi-channel input signal, generating a first output signal for the first channel based on the first gain limiter and the first input signal, and causing playback of the first output signal by a first speaker.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method comprising:
receiving a multi-channel input signal corresponding to an audio source;
determining that a first input signal for a first channel from the multi-channel input signal exceeds an input level threshold;
determining a first amount of time that the first channel exceeds the input level threshold;
computing a first release time for a first gain limiter associated with the first channel based on the first amount of time and an analysis of a plurality of channels from the multi-channel input signal;
generating a first output signal for the first channel based on the first gain limiter and the first input signal; and
causing playback of the first output signal by a first speaker.

2. The computer-implemented method of claim 1, further comprising:
computing a global release time for a remainder of other channels of the multi-channel input signal based on the first release time;
generating a respective output signal for each channel of the multi-channel input signal based on the global release time; and
causing playback of the respective output signal by at least one speaker.

3. The computer-implemented method of claim 2, wherein the global release time is based on a plurality of respective release times computed for each channel of the multi-channel input signal.

4. The computer-implemented method of claim 3, wherein the global release time comprises a longest release time from the plurality of respective release times.

5. The computer-implemented method of claim 1, further comprising:
identifying a second channel in a same frequency response group as the first channel;
applying the first release time to a second gain limiter associated with the second channel;
generating a second output signal for the second channel based on the second gain limiter and a second input signal corresponding to the second channel; and
causing playback of the second output signal by a second speaker.

6. The computer-implemented method of claim 1, further comprising:
identifying a second channel in a same location category as the first channel;
applying the first release time to a second gain limiter associated with the second channel;
generating a second output signal for the second channel based on the second gain limiter and a second input signal corresponding to the second channel; and
causing playback of the second output signal by a second speaker.

7. The computer-implemented method of claim 1, further comprising:
identifying a second channel in a same spatial group as the first channel;
applying the first release time to a second gain limiter associated with the second channel;
generating a second output signal for the second channel based on the second gain limiter and a second input signal corresponding to the second channel; and
causing playback of the second output signal by a second speaker.

8. The computer-implemented method of claim 1, wherein the first release time is based on a length of time that the first input signal exceeds the input level threshold.

9. The computer-implemented method of claim 8, wherein the first release time is proportional to a length of time that the first input signal exceeds the input level threshold.

10. The computer-implemented method of claim 1, further comprising:
determining that a second input signal for a second channel from the multi-channel input signal exceeds a second input level threshold;
determining a second amount of time that the second channel exceeds the second input level threshold;
computing a second release time for a second gain limiter associated with the second channel based on the first release time, the second amount of time and the analysis of the plurality of channels from the multi-channel input signal, wherein the first release time is further based on the second release time;
generating a second output signal for the second channel based on the second gain limiter and the second input signal; and
causing playback of the first output signal by the first speaker.

11. One or more non-transitory computer-readable media storing instructions that, that, when executed by one or more processors, cause the one or more processors to perform the steps of:
receiving a multi-channel input signal corresponding to an audio source;
determining that a first input signal for a first channel from the multi-channel input signal exceeds an input level threshold;
determining a first amount of time that the first channel exceeds the input level threshold;
computing a first release time for a first gain limiter associated with the first channel based on the first amount of time and an analysis of a plurality of channels from the multi-channel input signal;
generating a first output signal for the first channel based on the first gain limiter and the first input signal; and
causing playback of the first output signal by a first speaker.

12. The one or more non-transitory computer-readable media of claim 11, the steps further comprising:
computing a global release time for a remainder of other channels of the multi-channel input signal based on the first release time;
generating a respective output signal for each channel of the multi-channel input signal based on the global release time; and
causing playback of the respective output signal by at least one speaker.

13. The one or more non-transitory computer-readable media of claim 12, wherein the global release time is based on a plurality of respective release times computed for each channel of the multi-channel input signal.

14. The one or more non-transitory computer-readable media of claim 13, wherein the global release time comprises a longest release time from the plurality of respective release times.

15. The one or more non-transitory computer-readable media of claim 11, the steps further comprising:
identifying a second channel in a same frequency response group as the first channel;
applying the first release time to a second gain limiter associated with the second channel;
generating a second output signal for the second channel based on the second gain limiter and a second input signal corresponding to the second channel; and
causing playback of the second output signal by a second speaker.

16. The one or more non-transitory computer-readable media of claim 11, the steps further comprising:
identifying a second channel in a same location category as the first channel;
applying the first release time to a second gain limiter associated with the second channel;
generating a second output signal for the second channel based on the second gain limiter and a second input signal corresponding to the second channel; and
causing playback of the second output signal by a second speaker.

17. The one or more non-transitory computer-readable media of claim 11, the steps further comprising:
identifying a second channel in a same spatial group as the first channel;
applying the first release time to a second gain limiter associated with the second channel;
generating a second output signal for the second channel based on the second gain limiter and a second input signal corresponding to the second channel; and
causing playback of the second output signal by a second speaker.

18. The one or more non-transitory computer-readable media of claim 11, wherein the first release time is based on a length of time that the first input signal exceeds the input level threshold.

19. The one or more non-transitory computer-readable media of claim 18, wherein the first release time is proportional to a length of time that the first input signal exceeds the input level threshold.

20. A system comprising:
a memory storing instructions for a speaker protection application; and
a processor coupled to the memory that implements the speaker protection application by performing the steps of:
receiving a multi-channel input signal corresponding to an audio source;
determining that a first input signal for a first channel from the multi-channel input signal exceeds an input level threshold;
determining a first amount of time that the first channel exceeds the input level threshold;
computing a first release time for a first gain limiter associated with the first channel based on the first amount of time and an analysis of a plurality of channels from the multi-channel input signal;
generating a first output signal for the first channel based on the first gain limiter and the first input signal; and
causing playback of the first output signal by a first speaker.
